(19) United States
(12) Patent Application Publication
(10) Pub. No.: US 2026/0221857 A1
(43) Pub. Date: Jul. 30, 2026

(54) MAGNETIC REDUCER

(71) Applicant: AIMertech Co., Ltd., Changwon-si (KR)

(72) Inventor: Dae Jung Sung, Changwon-si (KR)

(21) Appl. No.: 19/366,582

(22) Filed: Oct. 23, 2025

(30) Foreign Application Priority Data
Jan. 24, 2025 (KR) 10-2025-0011329

(51) Int. Cl. H02K 51/00; H02K 1/2783; H02K 1/2792; H02K 7/00

(52) U.S. Cl. CPC H02K 51/00; H02K 1/2783; H02K 1/2792; H02K 7/003; H02K 2213/03

(57) ABSTRACT

Provided is a magnetic reducer. The magnetic reducer includes: a housing rotatably supporting the magnetic reducer; an input shaft assembly fixedly coupled to a rotary shaft of a motor that is inserted through an input hole of the housing; an inner magnetic flux assembly including an inner core supported on an outer circumferential surface of the input shaft assembly and inner magnets coupled to an outer circumferential surface of the inner core; an outer magnetic flux assembly including an outer core supported on an inner circumferential surface of the housing and outer magnets coupled to an inner circumferential surface of the outer core; and a pole piece unit including a pole piece holder and pole piece covers, the pole piece holder being supported on an inner surface of the housing.

### TECHNICAL FIELD

The present disclosure relates to a magnetic reducer.

### BACKGROUND ART

A magnetic reducer is a non-contact type power transmission device that controls a rotational motion by utilizing a magnetic force, and is spotlighted as a technology that replaces physical contact of a mechanical gear. Such a reducer may effectively reduce wear and noise caused by friction, thus ensuring high durability and reliability. In addition, such a reducer is evaluated as an economically efficient solution due to its low maintenance costs and low occurrence of failures.

Furthermore, the magnetic reducer is being highlighted more in an application field requiring precise rotational control. An industrial robot or an automation device requires precise position control, and the magnetic reducer is established as an ideal device satisfying such requirements. In addition, this technology is also widely utilized in electric vehicles, hybrid vehicles, and aerospace fields in order to simultaneously achieve light weight and energy efficiency.

The magnetic reducer essentially requires a design simultaneously considering durability and energy efficiency, and various research and development are being conducted for this purpose. For example, high-performance magnet arrangement technology is utilized in order to reduce loss of magnetic field and maximize efficiency. In addition, such a device is also closely related to the advancement of material technology for enhancing the strength and durability of magnets and core materials. A design utilizing high-strength lightweight alloys or heat-resistant materials contributes to extending the lifespan of the device, thereby enabling development of a reducer capable of operating stably even under a high-load environment.

Recently, research has been actively conducted to simultaneously pursue the miniaturization and high-output of the magnetic reducer. For example, continuous efforts are being made to improve a magnet arrangement designed to enable high-density energy transmission, a structural design supporting the arrangement, a pole piece unit structure for effectively transmitting a magnetic force between magnets, and the like.

As an example of technology forming the background of the present disclosure, Korean Patent Laid-Open Publication No. 10-2014-0013087 discloses a magnetic gear device including: a first magnet row having a plurality of magnetic poles respectively disposed; a second magnet row disposed to face the first magnet row; and a magnetic material row disposed between the first magnet row and the second magnet row, the magnetic material row having a plurality of magnetic materials respectively disposed at equal intervals.

### DISCLOSURE

### Technical Problem

An aspect of the present disclosure is to provide a magnetic reducer having durability and efficiency improved over those of a prior magnetic reducer.

An aspect of the present disclosure is to provide a magnet coupling structure of an inner magnetic flux assembly of a magnetic reducer for more stably maintaining an inner magnetic flux assembly structure and its coupling.

In addition, an aspect of the present disclosure is to provide a magnet arrangement structure and a pole piece unit structure for more efficiently transmitting a magnetic force between the inner and outer magnetic flux assemblys of the magnetic reducer.

In addition, an aspect of the present disclosure is to provide an input shaft assembly structure for enhancing a coupling force between a rotary shaft of a motor and the magnetic reducer.

In addition, an aspect of the present disclosure is to provide an emergency stop (E-stop) brake enabling an operation of the magnetic reducer to be stably stopped in an emergency.

Aspects of the present disclosure are not limited to the above-mentioned aspects, and other aspects that are not mentioned here may be obviously understood by those skilled in the art from the following specification.

### Technical Solution

According to an embodiment, a magnetic reducer may include: a housing rotatably supporting the magnetic reducer; an input shaft assembly fixedly coupled to a rotary shaft of a motor that is inserted through an input hole of the housing; an inner magnetic flux assembly including an inner core supported on an outer circumferential surface of the input shaft assembly and inner magnets coupled to an outer circumferential surface of the inner core; an outer magnetic flux assembly including an outer core supported on an inner circumferential surface of the housing and outer magnets coupled to an inner circumferential surface of the outer core; a pole piece unit including a pole piece holder and pole piece covers, the pole piece holder being supported on an inner surface of the housing, being positioned between the outer circumferential surface of the inner magnetic flux assembly and the inner circumferential surface of the outer magnetic flux assembly, and including a central ring coaxial with the inner magnetic flux assembly, protrusions arranged at regular intervals on an outer circumferential surface of the central ring, and pole piece holes axially passing through the protrusions, and the pole piece covers having irregularities engaged with side surfaces of the protrusions and fixedly coupled to the pole piece holder by pole piece pins penetrating through the pole piece holes; and an output shaft assembly detachably coupled to the outer magnetic flux assembly.

### Advantageous Effects

The present disclosure may more stably maintain the inner magnetic flux assembly structure and its coupling.

In addition, the present disclosure may more efficiently transmit the magnetic force between the inner and outer magnetic flux assemblys of the magnetic reducer.

In addition, the present disclosure may enhance the coupling force between the rotary shaft of the motor and the magnetic reducer.

In addition, the present disclosure may enable the operation of the magnetic reducer to be stably stopped in the emergency.

### DESCRIPTION OF DRAWINGS

In order to more fully understand the drawings mentioned in the detailed description of the present disclosure, a detailed description of each drawing is provided.

FIG. 1 illustrates a side cross-sectional view of a magnetic reducer according to an embodiment of the present disclosure.

FIG. 2 illustrates a longitudinal cross-sectional view of the magnetic reducer according to an embodiment of the present disclosure.

FIG. 3 illustrates an exploded perspective view of the magnetic reducer according to an embodiment of the present disclosure.

FIGS. 4A and 4B respectively illustrate perspective views of the input shaft and clamping ring of an input shaft assembly according to an embodiment of the present disclosure.

FIG. 5 illustrates an exploded perspective view of an inner magnetic flux assembly, an outer magnetic flux assembly, and a pole piece unit according to an embodiment of the present disclosure.

FIGS. 6A and 6B respectively illustrate perspective views of the inner magnetic flux assembly and the outer magnetic flux assembly according to an embodiment of the present disclosure.

FIG. 7 illustrates a front view of an inner core of the inner magnetic flux assembly according to an embodiment of the present disclosure.

FIG. 8 illustrates a front view of a pole piece holder according to an embodiment of the present disclosure.

FIG. 9 illustrates a shape of a protrusion of the pole piece holder according to an embodiment of the present disclosure.

FIGS. 10A, 10B, and 10C respectively illustrate a front view, a side view, and a rear view of an upper cover of the pole piece unit according to an embodiment of the present disclosure.

FIGS. 11A and 11B respectively illustrate a front view and a side view of a lower cover of the pole piece unit according to an embodiment of the present disclosure.

FIGS. 12A and 12B respectively illustrate a front view and a side view of an output shaft assembly according to an embodiment of the present disclosure.

### BEST MODE FOR INVENTION

Hereinafter, an operational principle of a preferred embodiment of the present disclosure is described in detail with reference to the accompanying drawings. In addition, in describing an embodiment of the present disclosure, a detailed description is omitted for a case where it is determined that such a detailed description of related known functions or configurations may obscure the gist of the present disclosure. The following terms are defined in consideration of corresponding functions in the present disclosure, and may vary depending on a user's intention, an operator's intention, or a convention. Therefore, definitions of the used terms should be interpreted based on contents throughout the specification and corresponding functions.

A magnetic reducer is a non-contact type device that transmits power and controls a rotational speed by using a magnetic force, and may transmit torque through an induced magnetic force utilizing a magnet arrangement and a conductive material instead of a physical gear. This technology may cause no friction, thereby minimizing wear and noise, and may offer low maintenance cost and excellent durability. The magnetic reducer may be applied to various fields requiring precision and reliability, such as industrial robots, electric and hybrid vehicles, medical equipment, and wind turbines. The magnetic reducer is developed to overcome limitations of a conventional mechanical reducer, and is gradually established as an essential technology in advanced industries by providing energy efficiency and smooth operation. Introduction of the magnetic reducer may enable efficient and economical power transmission through effects such as noise reduction, lifespan extension, reduced failure risk, and minimization of energy loss.

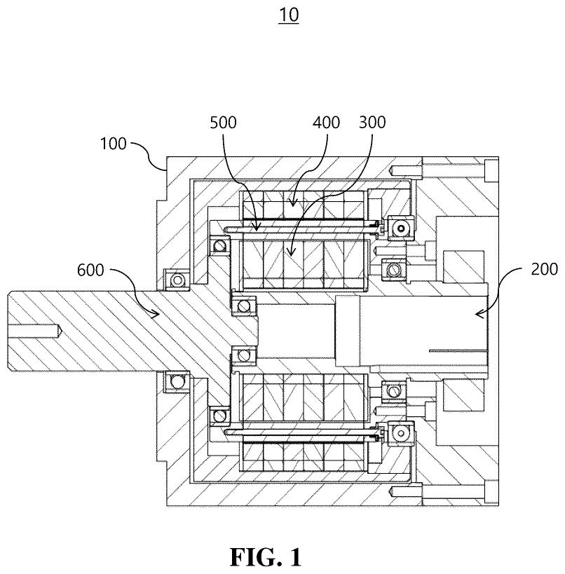

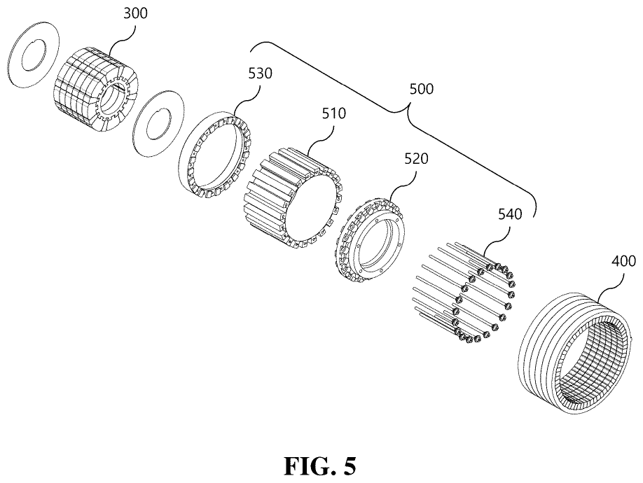

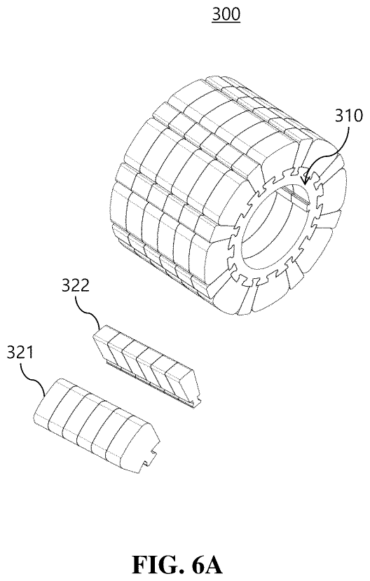

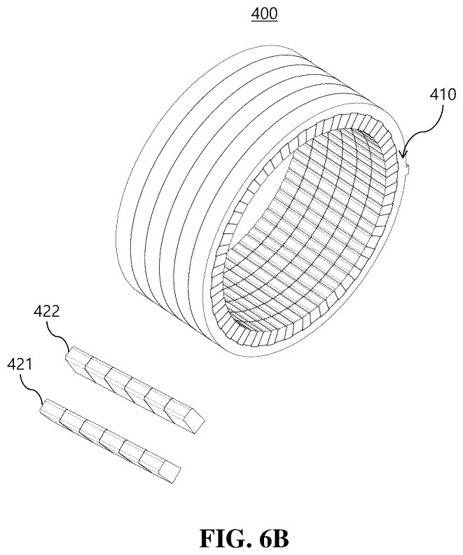

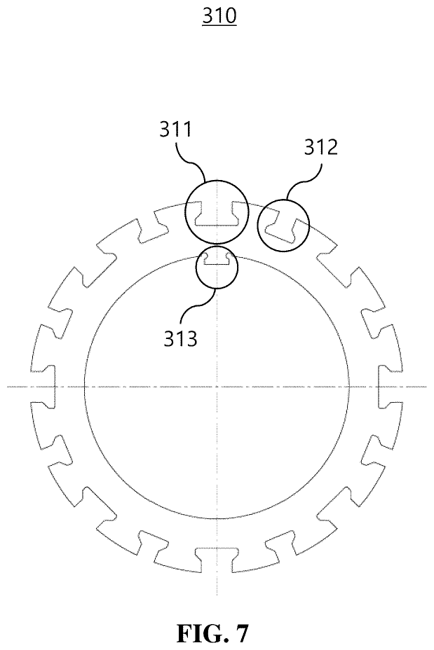

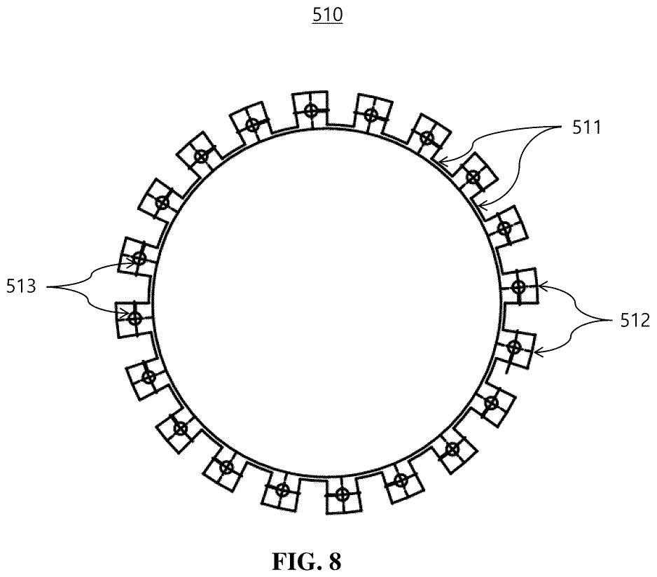

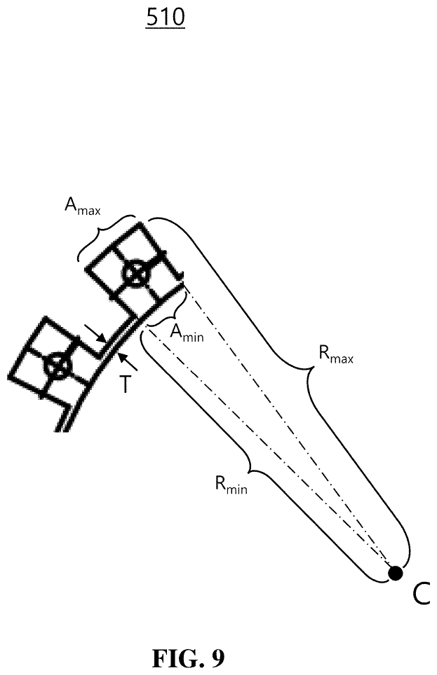

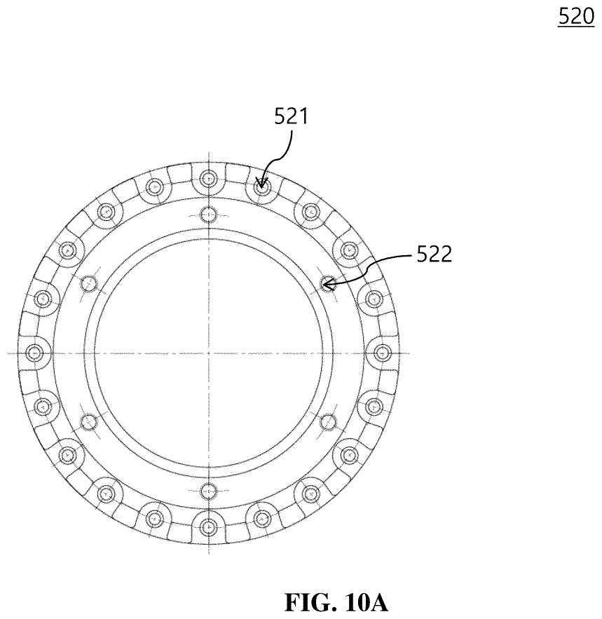

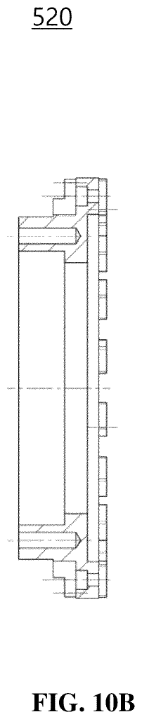

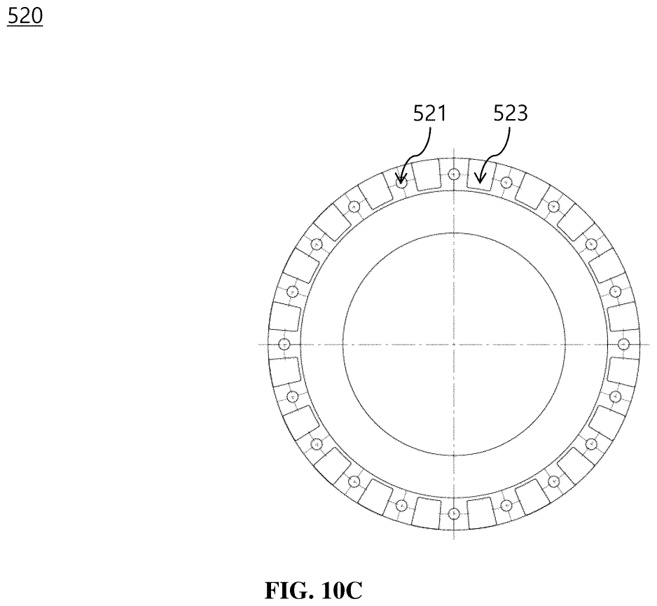

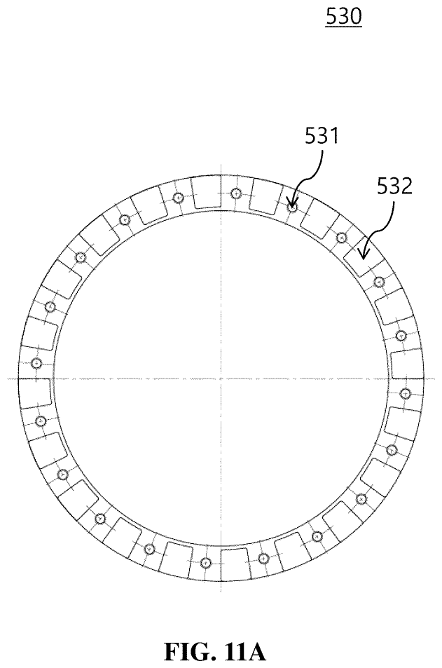

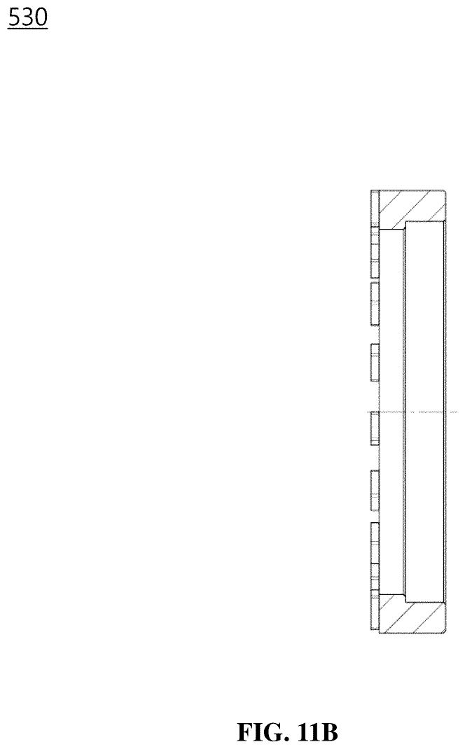

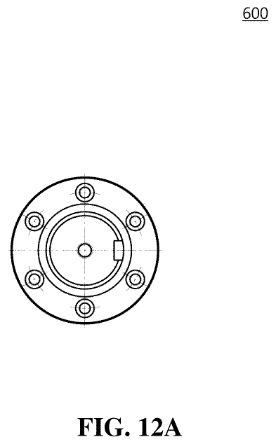

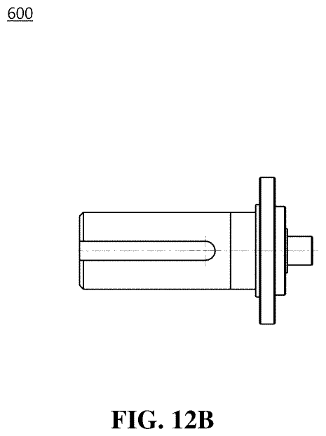

Referring to FIGS. 1 to 12, a magnetic reducer 10 according to an embodiment of the present disclosure may include a housing 100, an input shaft assembly 200, an inner magnetic flux assembly 300, an outer magnetic flux assembly 400, a pole piece unit 500, and an output shaft assembly 600. Hereinafter, each component is described in more detail.

The housing 100 may serve to support an exterior of the magnetic reducer 10 according to the present disclosure and stably dispose internal components. The housing 100 may include the input shaft assembly 200, the inner magnetic flux assembly 300, the outer magnetic flux assembly 400, the pole piece unit 500, and the output shaft assembly 600 according to the present disclosure, and may protect the internal components from external impact or vibration. In addition, the housing 100 may maintain a constant gap between the internal components to increase efficiency in a power transmission process.

The housing 100 may have a cylindrical shape and provide a supporting structure to enable the internal components to be stably operated. Here, the housing 100 may be made of an aluminum alloy material. Specifically, the housing 100 may be made of AL6061, which is an aluminum-magnesium-silicon-based alloy.

For example, the housing 100 may include at least one of an input-side brake and an output-side brake for stopping an operation of the magnetic reducer when a predetermined emergency stop (E-stop) condition is satisfied. Here, the predetermined E-stop condition refers to a state out of a range of torque and rotational speed that may be stably driven without the deterioration, overheating, breakage, or the like of the magnetic reducer 10 or a motor 20 according to the present disclosure, and may be set differently depending on the capacity and output of the magnetic reducer 10 or the motor 20 and an environment of each industrial site.

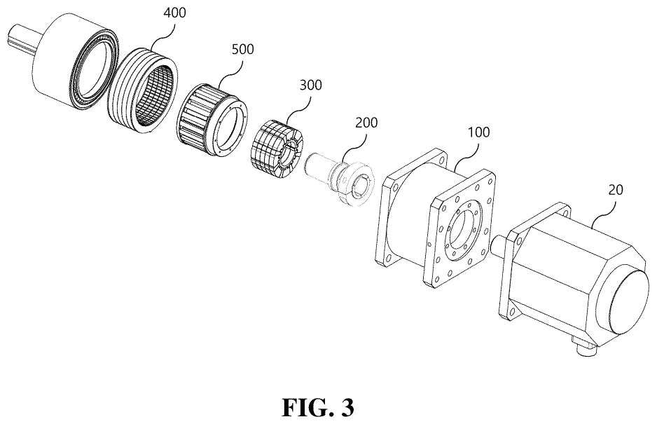

Here, referring to the housing 100 illustrated in FIGS. 1 and 3, the input-side brake (not shown) may be disposed in parallel on the inner surface of the housing 100 adjacent to the input shaft assembly 200, and the output-side brake (not shown) may be disposed in parallel on the inner surface of the housing 100 adjacent to the output shaft assembly 600.

The input shaft assembly 200 may be fixedly coupled to a rotary shaft of the motor 20 that is inserted through an input hole of the housing 100, and serve to transmit power of the motor 20.

For example, the input shaft assembly 200 may include: an input shaft 210 including an insertion hole into which the rotary shaft of the motor 20 is inserted and a clamping slot 211 disposed in an insertion direction of the rotary shaft; and a clamping ring 220 pressing an outer circumferential surface of the input shaft 210 to fixedly couple the input shaft 210 to the rotary shaft of the inserted motor 20. Here, the input shaft 210 may include the plurality of clamping slots 211 spaced apart at regular intervals along a circumference. In addition, the input shaft 210 may be made of chromium molybdenum (Cr-Mo) alloy steel. Specifically, the input shaft 210 may be made of SCM440. In addition, the clamping ring 220 may be made of carbon steel. Specifically, the clamping ring 220 may be made of SM45C.

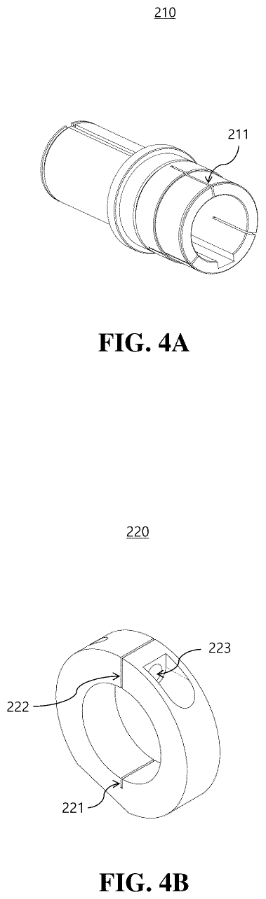

For example, as described with reference to FIG. 4, three clamping slots 211 may be spaced apart at regular intervals to form an angle of 120° with each other at an inlet portion of the input shaft 210, and the present disclosure is not limited thereto.

In addition, the clamping ring 220 may include a ring groove 221 and a ring slot 222 to tighten the inlet portion of the input shaft 210, and may press the outer circumferential surface of the input shaft 210 by tightening a screw inserted into a screw hole 223 to reduce a gap of the ring slot 222. The pressed input shaft 210 may have a reduced gap of the clamping slot 211, and accordingly, an inner circumferential surface of the input shaft 210 may be narrowed to press an outer circumferential surface of the rotary shaft of the motor 20, thereby being fixedly coupled strongly to the rotary shaft of the motor 20.

The inner magnetic flux assembly 300 may serve to transmit power transmitted from the input shaft assembly 200 to the outer magnetic flux assembly 400.

For example, the inner magnetic flux assembly 300 may include an inner core 310 supported on an outer circumferential surface of the input shaft assembly 200 and inner magnets 321 and 322 coupled to an outer circumferential surface of the inner core 310. Here, the inner core 310 may include T-shaped grooves 311 and 312 and a reference position groove 313 on the outer circumferential surface. The inner magnets 321 and 322 may be coupled to the T-shaped grooves 311 and 312, respectively. In more detail, the first inner magnet 321 may be coupled to the first T-shaped groove 311, and the second inner magnet 322 may be coupled to the second T-shaped groove 312. In addition, a structure that couples the inner core 310 and the inner magnets 321 and 322 to each other may stably fix positions of the magnets and prevent the inner magnets 321 and 322 from being separated due to a centrifugal force even at a high-speed rotation of the motor 20. In addition, the reference position groove 313 may function as a work reference for driving of the magnetic reducer 100, and may be coupled to the groove of the input shaft 210 to be rotated in synchronization with a rotation of the input shaft assembly 200.

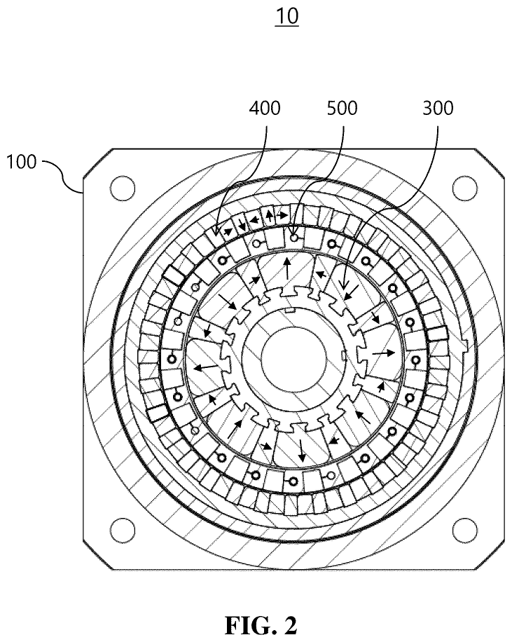

For example, referring to FIG. 2, the inner magnets 321 and 322 may be arranged in a Halbach Array to provide a stronger magnetic force to the outer magnetic flux assembly 400.

In addition, the inner magnets 321 and 322 may be stacked in an axial direction to reduce flux loss and enable highly efficient power transmission, thereby maximizing flux transmission efficiency.

The outer magnetic flux assembly 400 may serve to transmit power received through its magnetic interaction with the inner magnetic flux assembly 300 to the output shaft assembly 600.

For example, the outer magnetic flux assembly 400 may include an outer core 410 supported on an inner circumferential surface of the housing 100 and outer magnets 421 and 422 coupled to an inner circumferential surface of the outer core 410.

For example, referring to FIG. 2, the outer magnets 421 and 422 may be arranged in a Halbach Array to provide a stronger magnetic force.

In addition, the outer magnets 421 and 422 may also be stacked in the axial direction to reduce the flux loss and enable the highly efficient power transmission, thereby maximizing the flux transmission efficiency.

The pole piece unit 500 may serve to mediate and transmit magnetic flux between the inner magnetic flux assembly 300 and the outer magnetic flux assembly 400.

For example, the pole piece unit 500 may include a pole piece holder 510 and pole piece covers 520 and 530, the pole piece holder 510 being supported on an the inner surface of the housing 100, being positioned between an outer circumferential surface of the inner magnetic flux assembly 300 and an inner circumferential surface of the outer magnetic flux assembly 400, and including a central ring 511 coaxial with the inner magnetic flux assembly 300, protrusions 512 arranged at regular intervals on the outer circumferential surface of the central ring 511, and pole piece holes 513 axially passing through the protrusions 512, and pole piece covers 520 and 530 having irregularities engaged with side surfaces of the protrusions 512 and fixedly coupled to the pole piece holder 510 by pole piece pins 540 penetrating through the pole piece holes 513. Here, the pole piece holder 510 may be made of a glass epoxy laminate material. Specifically, the pole piece holder 510 may be made of G11. In addition, the pole piece pin 540 may be made of an insulation nano-coated aluminum alloy material. Specifically, the pole piece pin 540 may be made of AL6061. In addition, the pole piece cover 520 or 530 may be made of austenitic stainless steel. Specifically, the pole piece cover 520 or 530 may be made of SUS303.

In addition, in the present disclosure, a thickness T of the central ring 511 may be set to 1.9 mm to 2.1 mm, and preferably set to 2 mm. However, the present disclosure is not limited thereto, and the thickness T of the central ring 511 for optimizing performance of the magnetic reducer 10 may be set differently depending on specifications such as a gear ratio of the magnetic reducer 10, a strength of the magnets, an output of the motor 20, or the like.

In addition, the protrusion 512 may have a width larger in a circumferential direction as the protrusion 512 becomes farther from a rotary shaft center C of the magnetic reducer 10. The protrusion 512 may satisfy Equation 1 below to improve efficiency of the magnetic force between the inner magnetic flux assembly 300 and the outer magnetic flux assembly 400, and to uniformly maintain flux density.

Rₘᵢₙ/Rₘₐₓ=Aₘᵢₙ/Aₘₐₓ. [Equation 1]

Here, Rₘᵢₙ indicates the shortest distance from the rotary shaft center C of the magnetic reducer 10 to an inner side of the protrusion 512, Rₘₐₓ indicates a distance from the rotary shaft center C to an outer side of the protrusion 512, Aₘᵢₙ indicates a length of an inner arc of the protrusion 512, and Aₘₐₓ indicates a length of an outer arc of the protrusion 512.

In addition, the pole piece covers 520 and 530 may include the upper cover 520 and the lower cover 530. Here, the upper cover 520 may be engaged with one side surface of the protrusion 512 of the pole piece holder 510, may be supported on the inner surface of the housing 100, and may include a first fastening hole 521 communicated with the pole piece hole 513 for fastening to the pole piece holder 510 and a second fastening hole 522 for fastening to the housing 100. In addition, the lower cover 530 may be engaged with the other side surface of the protrusion 512 of the pole piece holder 510, and may include a third fastening hole 531 communicated with the pole piece hole 513 for fastening to the pole piece holder 510.

The pole piece hole 513 of the pole piece holder 510, the first fastening hole 521 of the upper cover 520, and the third fastening hole 531 of the lower cover 530 may be communicated with one another, and the pole piece pin 540 may be sequentially inserted into the first fastening hole 521, the pole piece hole 513, and the third fastening hole 531, thereby and fixedly coupling the holes to one another. In addition, an upper cover protrusion 523 may be inserted into a space between the protrusions 512 on one side surface of the pole piece holder 530, and a lower cover protrusion 532 may be inserted into a space between the protrusions 512 of the other side surface on the pole piece holder 530, thereby being coupled to each other.

In addition, the second fastening hole 522 of the upper cover 520 may be communicated with a coupling hole of the housing 100, and the pole piece unit 500 may be fixedly coupled to the housing 100 by a screw.

The output shaft assembly 600 may be coupled to the outer magnetic flux assembly 400 and serve to finally transmit a rotational force to a load.

For example, the output shaft assembly 600 may be detachably coupled to the magnetic reducer 10 and the outer magnetic flux assembly 400 according to the present disclosure. The output shaft assembly 600 may be detachable, and the output shaft assembly 600 having a shape suitable for the method and structure for connection to the load may thus be installed and used. Here, the output shaft assembly 600 may be made of chromium molybdenum (Cr—Mo) alloy steel. Specifically, the output shaft assembly 600 may be made of SCM440.

The output shaft assembly 600 may form a transmission path of a rotational motion by being coupled to the housing 100, and may minimize frictional loss by ball bearings disposed in the housing 100 and in contact with an outer circumferential surface of the output shaft assembly 600.

The above description is provided to merely illustrate the spirit of the present disclosure, and those skilled in the art to which the present disclosure pertains may make various modifications and changes without departing from essential features of the present disclosure. Therefore, the embodiments disclosed in the present disclosure are intended to describe the spirit of the present disclosure rather than to limit the present disclosure, and the spirit of the present disclosure is not limited to the embodiments. The scope of the present disclosure should be interpreted based on the appended claims, and all equivalent features within such a scope should be construed as being included in the scope of the present disclosure.

1. A magnetic reducer comprising:
a housing rotatably supporting the magnetic reducer;
an input shaft assembly fixedly coupled to a rotary shaft of a motor that is inserted through an input hole of the housing;
an inner magnetic flux assembly including an inner core supported on an outer circumferential surface of the input shaft assembly and inner magnets coupled to an outer circumferential surface of the inner core;
an outer magnetic flux assembly including an outer core supported on an inner circumferential surface of the housing and outer magnets coupled to an inner circumferential surface of the outer core;
a pole piece unit including a pole piece holder and pole piece covers,
the pole piece holder being supported on an inner surface of the housing, being positioned between the outer circumferential surface of the inner magnetic flux assembly and the inner circumferential surface of the outer magnetic flux assembly, and including
a central ring coaxial with the inner magnetic flux assembly,
protrusions arranged at regular intervals on an outer circumferential surface of the central ring, and
pole piece holes axially passing through the protrusions, and
the pole piece covers having irregularities engaged with side surfaces of the protrusions and fixedly coupled to the pole piece holder by pole piece pins penetrating through the pole piece holes; and
an output shaft assembly detachably coupled to the outer magnetic flux assembly.

2. The magnetic reducer of claim 1, wherein the housing includes at least one of an input-side brake and an output-side brake for stopping an operation of the magnetic reducer when a predetermined emergency stop (E-stop) condition is satisfied.

3. The magnetic reducer of claim 1, wherein the input shaft assembly includes:
an input shaft having an insertion hole into which the rotary shaft of the motor is inserted and a clamping slot disposed in an insertion direction of the rotary shaft; and
a clamping ring pressing an outer circumferential surface of the input shaft to fixedly couple the input shaft to the rotary shaft of the motor.

4. The magnetic reducer of claim 3, wherein the input shaft includes the plurality of clamping slots spaced apart at regular intervals along a circumference.

5. The magnetic reducer of claim 1, wherein the inner magnetic flux assembly includes:
the inner core having T-shaped grooves on an outer circumferential surface in an axial direction; and
the plurality of inner magnets engaged with the T-shaped grooves and surrounding the outer circumferential surface of the inner core.

6. The magnetic reducer of claim 1, wherein the inner magnets and the outer magnets each include a plurality of magnets, and
at least one of the inner magnets and the outer magnets is arranged in a Halbach Array along a circumferential direction.

7. The magnetic reducer of claim 5, wherein at least one of the inner magnets and the outer magnets is stacked in the axial direction.

8. The magnetic reducer of claim 1, wherein the pole piece covers of the pole piece unit include an upper cover and a lower cover,
the upper cover being engaged with one side surface of the protrusion of the pole piece holder, being supported on the inner surface of the housing, and including a first fastening hole communicated with the pole piece hole for fastening to the pole piece holder and a second fastening hole for fastening to the housing, and
the lower cover being engaged with the other side surface of the protrusion of the pole piece holder and including a third fastening hole communicated with the pole piece hole for fastening to the pole piece holder.

9. The magnetic reducer of claim 1, wherein the protrusion of the pole piece unit has a width larger in a circumferential direction as the protrusion becomes farther from a rotary shaft center of the reducer.

10. The magnetic reducer of claim 9, wherein the protrusion of the pole piece unit satisfies Equation 1 below:
Rₘᵢₙ/Rₘₐₓ =Aₘᵢₙ/Aₘₐₓ, [Equation 1]
where Rₘᵢₙ indicates a shortest distance from the rotary shaft center to an inner side of the protrusion, Rₘₐₓ indicates a distance from the rotary shaft center to an outer side of the protrusion, Aₘᵢₙ indicates a length of an inner arc of the protrusion, and Aₘₐₓ indicates a length of an outer arc of the protrusion.

11. The magnetic reducer of claim 1, wherein the central ring of the pole piece unit has a thickness of 1.9 mm to 2.1 mm.

12. The magnetic reducer of claim 1, wherein the pole piece holder is made of a glass epoxy laminate material,
the pole piece pin is made of an insulation nano-coated aluminum alloy material, and
the pole piece cover is made of austenitic stainless steel.

13. The magnetic reducer of claim 6, wherein at least one of the inner magnets and the outer magnets is stacked in the axial direction.
